(19) United States
(12) Patent Application Publication
(10) Pub. No.: US 2026/0203883 A1
(43) Pub. Date: Jul. 16, 2026

(54) RECONSTRUCTION OF FLANGE ELLIPSES TO DETECT MISALIGNMENT

(71) Applicant: Saudi Arabian Oil Company, Dhahran (SA)

(72) Inventors: Sahejad Patel, Thuwal (SA); Sabbir Rahman, Dhahran (SA); Hassane Trigui, Jeddah (SA); Frankly Leonardo Toro Gonzalez, Thuwal (SA); Siddharth Mishra, Dhahran (SA)

(21) Appl. No.: 19/020,231

(22) Filed: Jan. 14, 2025

(51) Int. Cl. G06T 7/00; G06T 3/40; G06T 5/70; G06T 7/13; G06T 7/60; G06T 7/73

(52) U.S. Cl. CPC G06T 7/0002; G06T 3/40; G06T 5/70; G06T 7/13; G06T 7/60; G06T 7/73; G06T 2207/20061

(57) ABSTRACT

A computer implemented method that enables reconstruction of flange ellipses to detect misalignment is described. The method includes applying a smoothing filter to an image comprising a flange joint. At least two edges corresponding to respective flanges of the flange joint are determined. A transformation to extract a first ellipse and a second ellipse corresponding to the at least two detected edges is performed. A position and orientation of the first ellipse and the second ellipse is estimated, and an alignment of the flanges is quantified based on the position and the orientation of the first ellipse and the second ellipse.

This disclosure relates generally to hydrocarbon exploration, drilling, and production, and more particularly, reconstruction of flange ellipses to detect misalignment.

### BACKGROUND

Flanges include projecting collars that serve to connect pressurized pipes or vessels, such as in a pipeline system. The pipeline system can guide hydrocarbons from a first location to a second location during hydrocarbon exploration, drilling, and production.

### BRIEF DESCRIPTION OF DRAWINGS

FIG. 1 shows a pipeline system that shows the distribution of hydrocarbons in the exploration, drilling, and production of hydrocarbons.

FIG. 2 shows misalignment of flange faces

FIG. 3 shows two flange joints.

FIG. 4 shows flanges and flange geometry.

FIG. 5 is a process flow diagram of a process that enables reconstruction of flange ellipses to detect misalignment.

FIG. 6 shows scenarios to detect flange alignment in view of flange geometry.

FIG. 7 illustrates hydrocarbon production operations that include both one or more field operations and one or more computational operations, which exchange information and control exploration for the production of hydrocarbons.

FIG. 8 is a schematic illustration of an example controller (or control system) for that enables reconstruction of flange ellipses to detect misalignment.

### DETAILED DESCRIPTION

Flanges enable connections between pipes of pipeline systems that transport various materials, such as oil, gas, water, and the like. Additionally, flanges can securely seal pressurized vessels that store various materials. A flange joint can include two flanges bolted together using a set of bolts mated with corresponding nuts. A gasket can be placed between the two flanges to create a tight seal. A seal is created between the flanges, enabling a strong joint or connection between two pipes, valves, pumps, or other equipment in a pipeline or piping system. Ensuring the integrity of flanges enables a safe piping system or pressurized vessel. In some cases, inspections of flanges in the field are conducted infrequently, as traditional inspections rely on a trained operator that travels to the system to visually inspect the flanges. Additionally, once on-site, an operator may find that flanges are located in difficult to view or hidden locations due to the design of the pipeline. Further, inexperienced operators are often unable to properly evaluate conditions of the flanges in traditional inspections. Accordingly, in traditional flange inspections operators require extensive, costly, and time consuming training in order to evaluate flanges.

Embodiments described herein enable reconstruction of flange ellipses to detect misalignment. In some embodiments, a computer vision approach is used to reconstruct flange ellipses to detect misalignments. In examples, computer vision is used to reconstruct geometric shapes created by edges of flanges. For example, by detecting at least two partial ellipses formed by edges of flange joints, a position and orientation of each flange of a flange joint is estimated. In the case of two ellipses, each ellipse represents one flange of the flange joint. If both ellipses are parallel and concentric, then the flange joint is considered aligned. The estimation accuracy of the orientation of the flanges is significantly increased with the detection of multiple geometric shapes corresponding to respective flanges of a flange joint. Moreover, the detection of multiple geometric shapes enables a reduction in the randomness in fitting the geometric shapes.

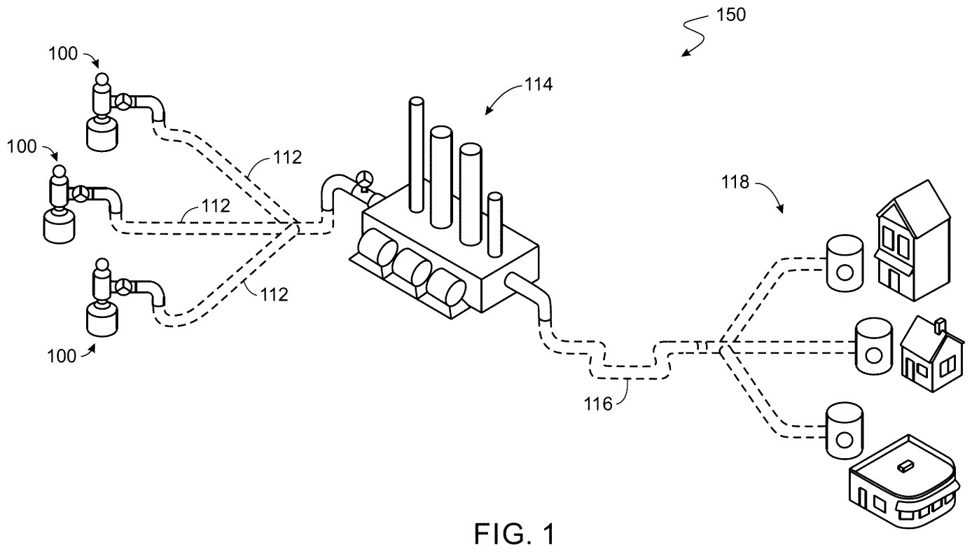

FIG. 1 shows a pipeline system 150 that distributes hydrocarbons associated with the exploration, drilling, and production of hydrocarbons. The pipeline system 150 is an infrastructure for transporting oil and gas to refineries or distribution centers. In the example of FIG. 1, hydrocarbons travel from various wells 100, to a processing facility 114, and on to various destination sites 118. Flanges are located throughout the pipeline system 150 to seal tanks or vessels, connect lengths of pipes, and otherwise enable the movement of hydrocarbons. The pipeline system 150 can be located onshore, offshore, or any combinations thereof. For example, portions of the pipeline system are positioned near an offshore or onshore well site. Portions of the pipeline system are positioned on platforms or floating vessels.

In examples, a respective well 100 includes a wellbore that has been drilled into a formation using a drill rig (not shown). The wells 100 are used to extract hydrocarbons from a formation and the hydrocarbons generally flow from the wells 100 to a processing facility 114. The wellheads of the wells 100 are structures that control the flow of fluids from wells, and can include one or more flanges. In examples, the processing facility 114 handles the initial processing of hydrocarbons extracted from wells. The processing facility separates, treats, and prepares the extracted hydrocarbons for further processing or transportation. For example, separating hydrocarbons includes separating a mixture of oil, gas, water, and solids extracted from the wells 100. This typically includes a primary separation to remove large volumes of water and gas, followed by secondary separation to further refine the oil and gas streams. Equipment used at the processing facility 114 to separate the hydrocarbons includes flanges to seal or pressurize the equipment.

In examples, after separation, the oil, gas, and water streams undergo treatment to remove impurities and contaminants. Treatment can include dehydration to remove water from gas and oil, desalting to remove salts from crude oil, and sweetening to remove hydrogen sulfide and other sulfur compounds from natural gas. Treaters of the processing facility 114 include units for treating fluids to meet quality standards, which can include flanges. After treatment, the oil and gas products are either stored in onsite tanks or transported via pipelines or tankers to refineries or distribution centers for further processing or distribution. The storage tanks, tankers, and pipelines include pressurized vessels sealed using flanges, and can also include flanges coupling pipes, vessels, or any combinations thereof.

The oil flows in a direction from a formation through wells 100, and into pipelines 112. Several wells and pipelines are connected to the oil processing facility 114. A transmission pipeline 116 carries the processed oil to various distribution pipelines and distribution sites 118. Various flanges are present in the pipeline system that connects, seals, or pressurizes the wells 100, pipelines 112, processing facilities, transmission pipelines 116, and distribution sites 118. Over time, respective flanges can become damaged or misaligned.

Flange joints exist on a vast scale across energy industrial facilities, such as the pipeline of FIG. 1. Flanges are monitored and maintained in order to prevent leaks and shutdowns. Strict inspection standards and maintenance protocols govern the operation of these flanges. Yet despite the stringent regulations, flange leaks remain a chronic challenge to in industrial facilities. Misalignment of flange faces is a precursor to flange joint leaks.

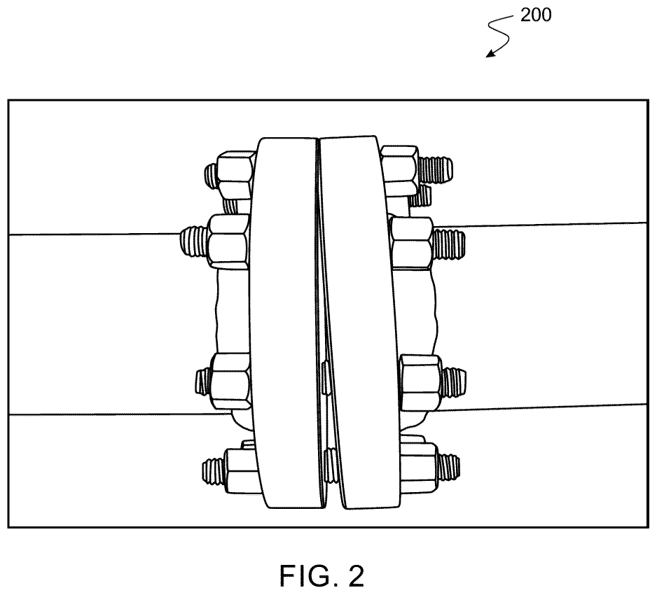

FIG. 2 shows a misalignment of flange faces 200. In examples, a flange face refers to the surface area of a flange that comes into contact with a gasket or another flange when two sections of a flange joint are coupled together. This surface is used to create a tight, leak-proof seal within the flange joint. In examples, the flange faces can be flat face, raised face, ring-type joint, lap joint, male and female, tongue and groove, or any combinations thereof. A flat face flange is configured such that the entire face of the flange is flat and in the same plane as the bolting circle face. A flat face flange is typically used in low-pressure applications. A raised face flange is configured such that the sealing surface is raised above the bolting circle face, which helps concentrate more pressure on a smaller area, improving the seal. A raised face flange is used in process plant applications. A ring-type joint flange has a groove cut into the face, where a metal ring gasket is seated. A ring-type joint flange is used in high-pressure and high-temperature applications. A male and female flange joint is configured such that one flange face has a raised area (male) and the other flange face has a matching recess (female). These are used to ensure proper alignment and sealing. A tongue and groove flange joint is configured such that one flange face has a tongue and another flange face has a matching groove. Tongue and groove flange joints are used in pump covers and other applications to enable precise alignment.

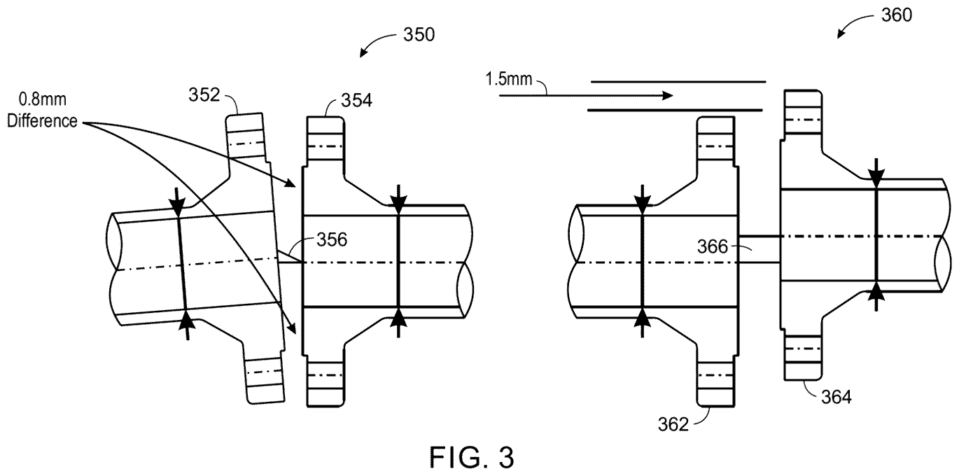

In examples, misaligned flanges are caused by uneven bolt tightening, loose bolts, missing bolts/nuts and various other conditions. Misaligned flanges can lead to undue pressures on the flange faces that ultimately result in leaks from the flange joint. Hence, detecting these misalignments early can result in planned maintenance and avoidance of these leaks. In examples, standards mandate that flange faces are aligned within +/−2 mm upon initial installation. Deviations from the alignment at the initial installation is tracked and corrected to ensure proper integrity of the flange joints. For an untrained or even a trained operator with a naked eye, these misalignments from the alignment at an initial installation are difficult to detect. Misalignments are usually of two types as shown in FIG. 3.

FIG. 3 shows two flange joints 350 and 360. The flange joints 350 and 360 show different types of misalignments. Each respective flange joint includes two flanges. The flanges are coupled by a number of bolts that extend through bolt holes in the collars of each respective flange. A number of nuts receive the threaded end of the bolts. Tightening the nuts secures the collars and of the coupled flange pair, creating a seal.

The flange joint 350 includes a flange 352 and a flange 354. The flanges 352 and 354 of the flange joint 350 are misaligned. In particular, the flange 352 and flange 354 show an angular misalignment, which is indicated by an angle 356 between a centerline of the flange 352 and a centerline of the flange 354.

The flange joint 360 includes a flange 362 and a flange 364. The flanges 362 and 364 of the flange joint 360 are misaligned. In particular, the flange 362 and flange 364 show a parallel misalignment, which is indicated by a shift or offset 366 between a centerline of the flange 362 and a centerline of the flange 364.

In examples, a flange collar is circular to enable a uniform stress distribution. For example, the circular shape enables a uniform distribution of stress around the flange, where the stress is from the bolts and the pressure within the pipe or vessel being sealed. Circular flanges enable ease of alignment where the symmetry of the circle enables for straightforward rotation and positioning resulting in an efficient assembly process. The circular shape can withstand internal pressures of high-pressure applications without deforming.

In some embodiments, a surface of the flanges (including the flange faces) is subjected to wear and tear, which causes defects including, for example, scratches, gouges, pits, and dents. In examples, scratches are caused by contact with hard, abrasive materials, and can result from mishandling in transit or from the removal of protective coatings. In examples, gouges are created by a dull object dragging across the flange face, such as a screwdriver. Gouges can occur in the flange during transit from the fabrication plant to site, or during commissioning. Pits are small rounded areas of material loss, sometimes in groups and caused by corrosion. In examples, pits are created after the flanges are operational for a period of time. Similarly, dents can be caused during the installation and commissioning phases through impact with equipment such as cables, rigging and positioning of mating flanges.

Defects in the surfaces of a flange can alter the appearance of the flange. In traditional approaches, changes in the appearances of a flange can mask detection of misalignments using artificial intelligence or traditional approaches. The present techniques reconstruct a geometry of a flange surface to detect misalignment. Geometric shapes derived from flanges as captured in an image are reconstructed based on information known about the flanges. A position and orientation of the geometric shapes is determined and used to quantify a misalignment of the flange joint. In examples, the position of a geometric shape refers to its location in space. The position can be defined by the coordinates of a reference point on the shape, such as the center. The orientation of the geometric shape describes how it is rotated or aligned relative to a reference frame. This orientation can be specified using angles, vectors, and the like.

In examples, the present techniques include an intelligent system that assesses an overall integrity of flanges by analyzing images of a flange joint captured by a camera. In examples, the camera is a Red/Green/Blue camera. Additionally or alternatively, in examples the image captured by the camera is a grayscale, multispectral, or hyperspectral image. Traditional flange inspections are physical in nature and require trained operators to interact with the flange to detect anomalies using metering tools such as calipers. Further, the use of artificial intelligence based models trained on RGB images to detect flange anomalies consumes large amounts of data for training. The present techniques do not rely on trained models, and thus training data is not used. The present techniques use computer vision to detect flange misalignments without using prior data and training.

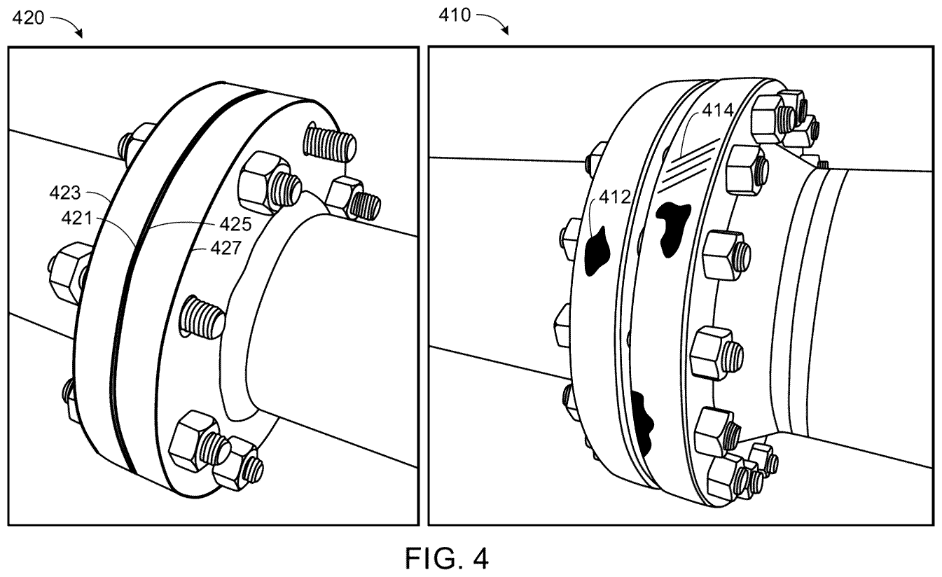

FIG. 4 shows flanges and flange geometry. At image 410, the flange is shown with defects, including an uneven coloration 412 and scratches 414. Flanges develop uneven coloration, scratches, gouges, pits, dents, corrosion and soiling over time. In some embodiments, each flange of a flange joint shows different defects, such as a different color and scratches on respective flanges of the flange joint. Further, lighting conditions can be different on respective flanges of the flange joint. For example, lighting conditions change depending on an angle and position of image capture. Poor lighting conditions can result in images with dark areas that render the boundaries of the respective flanges of the flange joint difficult to visually observe. Traditionally, standard segmentation can fail to accurately detect the geometry of a flange with defects.

The present techniques detect misalignment of flanges based on a circular shape of the flange. The flanges generally have a circular shape, which in perspective maps to ellipses in 3D perspective. For example, a flange collar appears oval shaped as the image plane shifts or tilts such that edges of the flange collar are visible. As an image plane shifts with respect to the flange joint, edges of the flanges appear as partial ellipses. In two-dimensional image capture, a circular flange transitions to an ellipse by changing an angle of image capture. This shift in perspective alters the apparent distances and ellipse shapes in the captured images.

Image 420 shows partial ellipses reconstructed from an image of a flange joint. At the flange joint, there are four partial ellipses, two inner partial ellipses 423 and 425, and two outer partial ellipses 421 and 427. In some embodiments, one partial ellipse per each respective flange of a flange joint is extracted from an image to describe the geometric shapes formed by edges of the flange joint. The amount of visibility of each partial ellipse is dependent upon an angle of image capture. The front edge of each partial ellipse relative to the camera is mostly visible. In the image 420, the partial ellipse 427 nearest to the camera is most visible when compared to the remaining partial ellipses 421, 423, and 425. Obstructions such as pipes, vessels, and other infrastructure can obscure full view of ellipses, and the ellipses themselves are often imperfect due to corrosion or soiling.

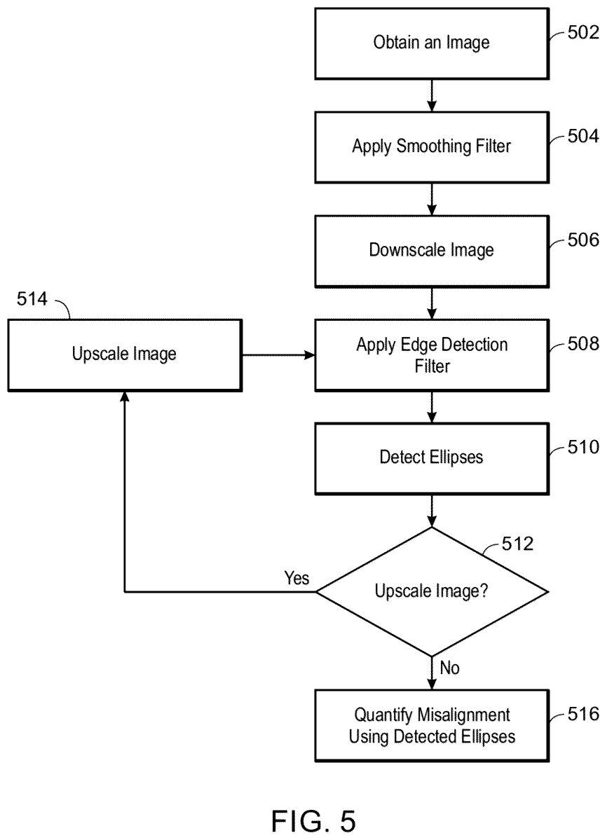

FIG. 5 is a process flow diagram of a process that enables reconstruction of flange ellipses to detect misalignment. At block 502, an image of the flange joint and size information is obtained. The image can be obtained from a database that stores images of flange joints. In examples, the images are high-quality RGB/optical images captured by a camera. Flange size information includes information about the scale of the flanges in the image. Flange size information enables accurate determination of the absolute distance between the flange surfaces and also their misalignment, e.g. in millimeters.

In examples, the image is captured by centering the flange joint in the camera frame. For example, the camera is positioned with an offset angle from the center of the flange as depicted in the image 420 of FIG. 4. Capturing an image of the flange at an offset angle enables detection of the curvature of the ellipses and hence improve fitting. In some embodiments, the entire flange is completely contained within the image. In some embodiments, the angle of image capture is such that the camera is positioned substantially vertical or horizontal with respect to centerlines of the flanges. For example, an angle of image capture that is substantially vertical with respect to the flanges is a substantially ninety degree angle with respect to a horizontal plane formed by a centerline of at least one flange of the flange joint. An angle of image capture that is substantially horizontal with respect to the flanges is a substantially zero degree angle with respect to a horizontal plane formed by a centerline of at least one flange of the flange joint.

In some embodiments, an object detection algorithm is used to recognize the geometry of the of the flange joint. The output of the object detection is a bounding box surrounding the flange joint. Alternatively, a manual bounding box can be drawn on the image of the flange joint to focus the attention of the algorithm on the flange. In some embodiments, the object detection algorithm reduces a search space for detection of ellipses corresponding to edges of the flanges. The object detection algorithm extracts features from the image corresponding to edges of respective flanges. Potential areas in the image where flange edges are located are identified using, for example, selective searches or region proposal networks (RPNs). Each proposed region is classified to determine the edges located within the region, and a respective location of the edges is identified. A location of an edge is designated by a bounding box, and further processing to detect partial ellipses is applied to the detected bounding boxes.

At block 504, a smoothing filter is applied to the images. In some embodiments, the smoothing filter is applied to areas of the image within the detected bounding boxes. In some embodiments, the smoothing filter is a Gaussian smoothing filter. The smoothing filter is used to preprocess the image in order to prepare the image for further processing. The smoothing filter reduces the effects of defects shown in the flange image, such as corrosion at the edges of the flange. The smoothing filter improves the efficiency of the ellipse detection. In examples, the smoothing filter reduces noise in an image by applying a Gaussian function to the image, resulting in a smooth, blurred effect. For example, a Gaussian function is applied to each pixel in the image to reduce noise while preserving edges and boundaries in the image.

At block 506, the image is downscaled. In examples, downscaling reduces the dimensions of an image, making the image smaller in terms of pixel count. In some embodiments, the size of the image is reduced by a power of two, such as 1/16 th or ⅛ th of the original image size. In a first iteration, the downscaled image is analyzed to obtain approximate positions of flange ellipses. For example, the size of the downscaled image is a width and height of 256×256. At a next iteration, the width and height of the image is 512×512, and at the next iteration the width and height of the image is 1024×1024, and so on. Downscaling ensures that images used to detect misalignment are at a known dimensions to maintain consistency and avoid issues during processing.

Downscaling the image reduces a resolution of the image, making it faster and less resource-intensive to process. Accordingly, downscaling enables real-time flange misalignment detection. Moreover, processing the image at different scales ensures features are captured at varying levels of detail. Iteratively capturing features enables detection of respective flange ellipses that might not be visible at the original image dimensions. When iteratively processing the image at varying scales, the coordinates of the bounding boxes are adjusted proportionally. For example, if the image is downscaled by a power of two, the coordinates of the bounding boxes are also scaled down by a power of two. The aspect ratio of the bounding boxes remains the same, ensuring that the relative positions and sizes of the detected edges are preserved.

At block 508, an edge detection filter is applied to the current image. In some embodiments, the edge detection filter operates on the identified bounding boxes. An edge detection filter, such as a Scharr filter, is used to emphasize strong boundaries and de-emphasize slowly varying changes in boundaries of the flange. In particular, the edge detection filter facilitates detection of the partial ellipses corresponding to boundaries of the flange. The edge detection filter identifies and locates the boundaries or edges of flanges within the image by calculating a gradient of the image intensity at each pixel. In examples, this gradient represents a rate of change in intensity, which is highest at the edges. The filter applies a threshold to the gradients to determine which gradients indicate edges of the flange. In some embodiments, the threshold is based on characteristics of the image, such as lighting conditions. Additionally or alternatively, in some embodiments, the threshold is adaptively set based on the image content. In some embodiments, the output of the edge detection filter is a binary image where the edges are identified and non-edge pixels are set to zero or a null value.

At block 510, ellipses are detected in the current image. In some embodiments, a Hough transform is used to detect ellipses in the current image. In examples, the Hough transform is used to detect partial ellipses corresponding to the edges of respective flanges of the flange joint. For example, the Hough transform is applied to the binary edge-detected image output by the edge detection filter to detect the partial ellipses. The Hough transform converts an edge in the image space of an image into a parameter space. For example, an edge in the image space is represented by parameters in the Hough space. A vote is tallied for each edge in the parameter space and accumulated in an accumulator array, where each cell represents a specific shape parameter. The local maxima in the accumulator array correspond to the most likely shapes present in the image, such as partial ellipses. In some embodiments, the detected ellipses are located at or near the center of the image and oriented parallel to each other. In examples, a first ellipse corresponds to a first flange of the flange joint and a second ellipse corresponds to a second flange of the flange joint.

In some embodiments, at least two ellipses are detected, with a first ellipse corresponding to a first flange, and a second ellipse corresponding to a second flange. In some embodiments, at least four ellipses are detected, with a first ellipse and a second ellipse corresponding to a first flange, and a third ellipse and a fourth ellipse corresponding to a second flange. For example, the detected ellipses are four roughly parallel, equally sized, roughly horizontal or vertical, centrally positioned ellipses. In examples, ellipses associated with a same flange are located within a predetermined distance of each other based on the flange size information captured at block 502. For example, the flange size information can include known dimensions of the flanges. Edges that are located corresponding to the known dimensions of a flange are identified as belonging to the same flange.

By resizing the image to a smaller size, less time is consumed when detecting ellipses in a respective image. The detecting ellipses can be computationally intensive as each pixel in the image where the ellipses may be present is evaluated, where multiple sizes and orientations of the ellipses are possible at each pixel. Detecting ellipses in smaller images reduces the number of pixels and the number of possible sizes and orientations that are in the larger image. In examples, detected ellipses are identified according to a location, size and orientation of each respective ellipse. Reducing possible sizes and orientations of ellipses by downscaling the image reduces the computation time associated with the Hough transform, and provides more accurate results at the higher resolution in the larger images.

At block 512, it is determined if a next upscaled image is to be analyzed. A downscaled image is progressively upscaled until the original full size image is used for ellipse detection. If a next upscaled image is analyzed, process flow proceeds to block 514 where the current image is upscaled. In examples, upscaling the image refers to doubling the size of the image. Additionally, in examples, a smoothing filter is iteratively combined with the edge detection filter (block 508) and the ellipse detection (block 510) to detect ellipses in the presence of noise on the flanges, such as rough edges or the presence of rust which can affect the elliptical shape reflected in the images.

When detecting ellipses, analyzing a smaller downscaled imaged first can simplify ellipse detection by reducing noise and computational costs. The results from the downscaled images are used as an approximation for ellipse parameters such as center, axes length, orientation, and the like the larger upscaled images. Process flow returns to block 508 where an edge detection filter is applied to the upscaled image, with ellipse parameters such as the center, axes length, orientation interpolated from the downscaled image to the upscaled image. Moreover, the edges detected in a smaller downscaled image inform the next iteration of edge detection at block 508 for an upscaled image. At least two ellipses that correspond to flanges of the flange joint are detected by iteratively applying an edge detection filter at block 508 followed by detecting ellipses at block 510.

In some embodiments, the detection of ellipses is optimized by progressively increasing the image size, doubling the image size at each iteration until the original full-size image is evaluated at blocks 508 and 510. Each iteration is seeded with the results from the previous iteration. This enhances the efficiency of the partial ellipse detection. Referring again to block 512, if the image size used to detect ellipses is equal to the original image size (initialized with results from a previous iteration), a next upscaled image is not analyzed and process flow proceeds to block 516.

At block 516, the misalignment of the flange joint is quantified using the detected ellipses. In some embodiments, the geometry and orientation of the flanges is determined based on the detected ellipses. In examples, the detected size, location, and orientation of the partial ellipses in an image are combined with the flange size information to determine a spatial location and orientation of each flange. For example, a three-dimensional (3D) geometric transformation from the detected ellipses to real-world locations is used to map the location of the flanges in the image. The 3D transformation is used to calculate rotational or translation misalignment between the flange of the image. In some embodiments, image properties such as a position and orientation of image capture are used to transform the detected ellipse coordinate from the image space to the real-world space.

Flange size information is used to scale the measurements to real world dimensions. For example, the ellipses are transformed to real world coordinates. The flange size (e.g., real world flange size) is used to calculate a precise distance to the flange, which can be determined using the 3D geometric transformation of the flange. Known flange information is combined with the measured geometry and orientation of the ellipses to obtain scaled measurements corresponding to each respective flange of the flange joint. The scaled measurements are used to quantify misalignment. For example, the calculated, precise location and orientation of the two opposite surfaces of the flange are used to determine the 3D positions of the centers of the two circles representing the flange in the real world, and their respective normal vectors. The two circles representing the flange in the real world and the normal vectors are used to calculate both the maximum and minimum distances between corresponding points on the two flanges as well as their rotational misalignment by comparing the directions of the normal vectors and calculating the angular difference between them.

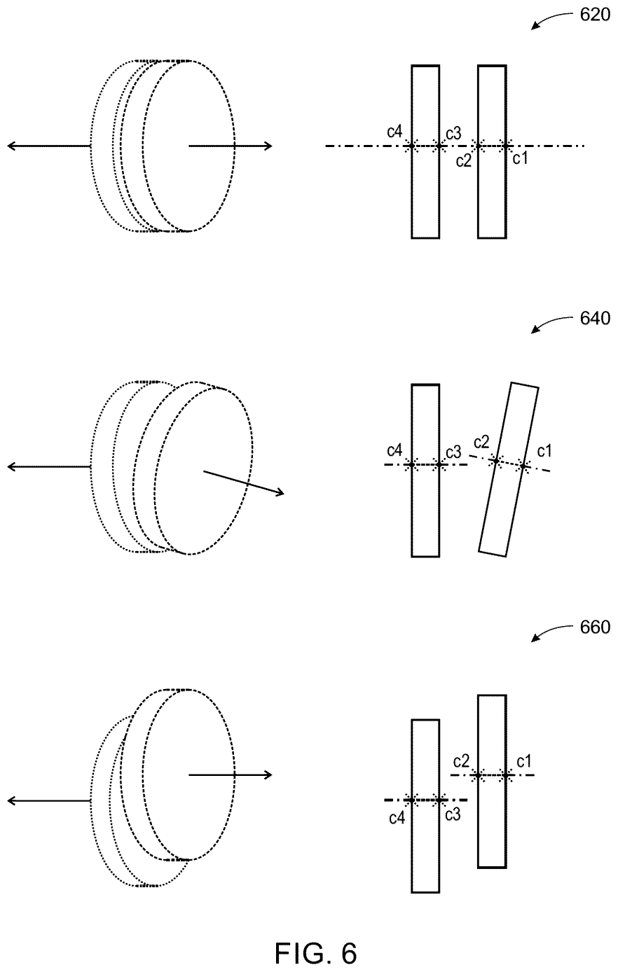

FIG. 6 shows scenarios where detecting flange alignment in view of the flange geometry. An aligned flange joint is shown at reference number 620. A flange joint with rotational misalignment is shown at reference number 640. A flange joint with vertical misalignment is shown at reference number 660. In some embodiments, a position of the centers of the partial ellipses are estimated using the Hough transform, based on an assumption that the partial ellipses are parallel and concentric. A line that intersects with the centers of two parallel partial ellipses can be used to determine the amount of misalignment in the flange. In the example of FIG. 6, flange surfaces are illustrated with corresponding centerlines (c1c2 and c3c4) that are determined from the detected ellipses, where: c1 refers to a detected center of a first ellipse; c2 refers to a detected center of a second ellipse; c3 refers to a detected center of a third ellipse; and c4 refers to a detected center of a fourth ellipse.

For aligned flange joint at reference number 620, the two lines c1c2 and c3c4 are positioned such that (1) no angle of misalignment exists between the lines and (2) no shift or offset between the lines exists. For the rotational misalignment of the flange joint at reference number 640, the two lines c1c2 and c3c4 are not parallel and form an angle indicating the rotational misalignment. For the vertical misalignment of the flange joint flange joint at reference number 660, the two lines c1c2 and c3c4 are parallel but not coplanar, forming a shift or offset between the parallel centerlines.

In some embodiments, the detection of misalignment is based on at least two ellipses, one from each flange of a flange joint. However, using four ellipses, two from each flange of a flange joint, increases an accuracy of misalignment detection. In some embodiments, when using two ellipses a center of the ellipses is used to determine the vertical misalignment, and the normal vector of the two ellipses can be used to determine the angular misalignment.

The present techniques use computer vision techniques to detect flange anomalies and more specifically misalignments. Images of the flanges are analyzed to detect misalignments. As such, this technique can be applied when the data is limited, when reliable models are unable to be trained, or in combination with other artificial intelligence based approaches. In some embodiments, the misalignment detected using computer vision techniques as described herein is executed in parallel with artificial intelligence based flange detection where a maximum likelihood approach is applied to the available data. In some embodiments, the output of the misalignment detected using computer vision techniques as described herein and corresponding uncertainties are combined with the outputs of artificial intelligence based flange detection techniques (and their uncertainties if available), and the maximum likelihood approach is selected if the outputs are compatible, or doing so after first rejecting any results which can be seen visibly to be incorrect.

The proposed solution introduces a computer vision-based solution to predict asset integrity (flanges in particular). The present techniques are useful when data is limited or unavailable for artificial intelligence model training. Thus, the present techniques detect flange misalignments without any need for prior data and training. Further, the present techniques support inspection and observation of flange joints from a side view and linking it to the rotational and vertical misalignments.

Moreover, the use of a Hough transformation for detecting various types of shapes such as ellipses is efficient and consistent, even in view of surface defects of the flange. Traditionally, the flange inspection methods are physical in nature and require trained operators to interact with the flange to detect anomalies. The present techniques enable robust detection of misalignments in the presence of various environmental field conditions such as sunlight, dust, corrosion etc. Further, the present techniques enable an automatic contactless flange inspection, resulting in a lower cost that manual process, and less time spent per inspection. Moreover, less experience and training required. Historical data is automated, and multiple anomalies can be detected in a single inspection.

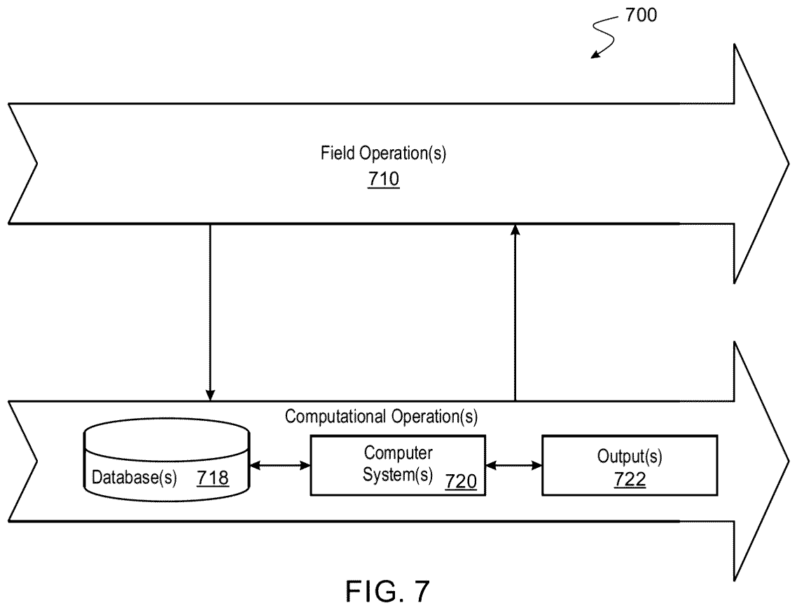

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure can be performed before, during, or in combination with the hydrocarbon production operations 700, specifically, for example, either as field operations 710 or computational operations 712, or both.

Examples of field operations 710 include forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

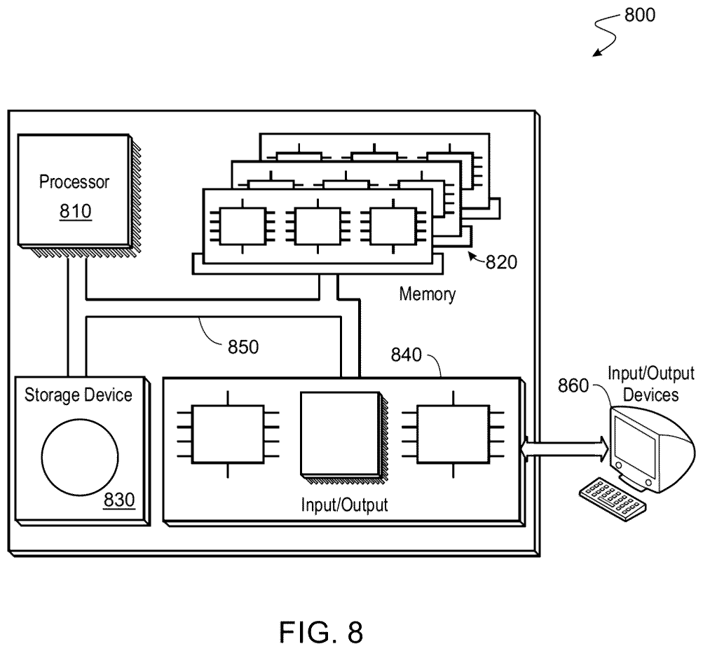

FIG. 8 is a schematic illustration of an example controller 800 (or control system) for that enables reconstruction of flange ellipses to detect misalignment. For example, the controller 800 may be operable according to the workflow 500 of FIG. 5. In some embodiments, the controller 800 is the same as or similar to the computer systems 720 of FIG. 7. The controller 800 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output interface 840 communicatively coupled with input/output devices 860 (for example, displays, keyboards, measurement devices, sensors, valves, pumps). Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output interface 840.

The memory 820 stores information within the controller 800. In one implementation, the memory 820 is a computer-readable medium. In one implementation, the memory 820 is a volatile memory unit. In another implementation, the memory 820 is a nonvolatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, or a tape device.

The input/output interface 840 provides input/output operations for the controller 800. In one implementation, the input/output devices 860 includes a keyboard and/or pointing device. In another implementation, the input/output devices 860 includes a display unit for displaying graphical user interfaces.

There can be any number of controllers 800 associated with, or external to, a computer system containing controller 800, with each controller 800 communicating over a network. Further, the terms “client,” “user,” and other appropriate terminology can be used interchangeably, as appropriate, without departing from the scope of the present disclosure. Moreover, the present disclosure contemplates that many users can use one controller 800 and one user can use multiple controllers 800.

### EMBODIMENTS

According to some non-limiting embodiments or examples, provided is a computer-implemented method that enables reconstruction of flange ellipses to detect misalignment, including: applying a smoothing filter to an image including a flange joint; detecting at least two edges corresponding to respective flanges of the flange joint by downscaling the image and detecting edges in the downscaled image, where the detected edges are identified in a binary image; applying a transformation to extract a first ellipse and a second ellipse corresponding to the at least two detected edges identified in the binary image, where a size of the downscaled images is iteratively increased, edges detected at each iteration, and ellipses extracted based on the detected edges until ellipses are extracted from an original size image; estimating a position and an orientation of the first ellipse and the second ellipse extracted from the original size image; and quantifying an alignment of the flanges based on a position and an orientation of the first ellipse and the second ellipse.

According to some non-limiting embodiments or examples, provided is an apparatus including a non-transitory, computer readable, storage medium that stores instructions that, when executed by at least one processor, cause the at least one processor to perform operations including: applying a smoothing filter to an image including a flange joint; detecting at least two edges corresponding to respective flanges of the flange joint by downscaling the image and detecting edges in the downscaled image, where the detected edges are identified in a binary image; applying a transformation to extract a first ellipse and a second ellipse corresponding to the at least two detected edges identified in the binary image, where a size of the downscaled images is iteratively increased, edges detected at each iteration, and ellipses extracted based on the detected edges until ellipses are extracted from an original size image; estimating a position and an orientation of the first ellipse and the second ellipse extracted from the original size image; and quantifying an alignment of the flanges based on a position and an orientation of the first ellipse and the second ellipse.

According to some non-limiting embodiments or examples, provided is a system, including: one or more memory modules; one or more hardware processors communicably coupled to the one or more memory modules, the one or more hardware processors configured to execute instructions stored on the one or more memory modules to perform operations including: applying a smoothing filter to an image including a flange joint; detecting at least two edges corresponding to respective flanges of the flange joint by downscaling the image and detecting edges in the downscaled image, where the detected edges are identified in a binary image; applying a transformation to extract a first ellipse and a second ellipse corresponding to the at least two detected edges identified in the binary image, where a size of the downscaled images is iteratively increased, edges detected at each iteration, and ellipses extracted based on the detected edges until ellipses are extracted from an original size image; estimating a position and an orientation of the first ellipse and the second ellipse extracted from the original size image; and quantifying an alignment of the flanges based on a position and an orientation of the first ellipse and the second ellipse.

Further non-limiting aspects or embodiments are set forth in the following numbered embodiments:
Embodiment 1: A computer-implemented method that enables reconstruction of flange ellipses to detect misalignment, including: applying a smoothing filter to an image including a flange joint; detecting at least two edges corresponding to respective flanges of the flange joint by downscaling the image and detecting edges in the downscaled image, where the detected edges are identified in a binary image; applying a transformation to extract a first ellipse and a second ellipse corresponding to the at least two detected edges identified in the binary image, where a size of the downscaled images is iteratively increased, edges detected at each iteration, and ellipses extracted based on the detected edges until ellipses are extracted from an original size image; estimating a position and an orientation of the first ellipse and the second ellipse extracted from the original size image; and quantifying an alignment of the flanges based on a position and an orientation of the first ellipse and the second ellipse.
Embodiment 2: The computer implemented method of any preceding embodiment, where the ellipses detected at each iteration are used to inform edge detection and ellipse extraction at a next iteration.
Embodiment 3: The computer implemented method of any preceding embodiment, where the smoothing filter is applied to bounding boxes of the image identified using object detection to smooth noise associated with detected objects in the image.
Embodiment 4: The computer implemented method of any preceding embodiment, where downscaling the image includes reducing a size of the image by a power of two and downsizing bounding boxes detected in the image.
Embodiment 5: The computer implemented method of any preceding embodiment, where detecting the at least two edges includes identifying edges of the respective flanges of the flange joint by calculating a gradient of an image intensity at each pixel.
Embodiment 6: The computer implemented method of any preceding embodiment, where quantifying an alignment of the flanges includes determining an angle of rotational misalignment or an offset of a parallel misalignment of the flanges by transforming the first ellipse and the second ellipse to real world coordinates and calculating rotational or translation misalignment based on the real world coordinates.
Embodiment 7: The computer implemented method of any preceding embodiment, where quantifying an alignment of the flanges based on a position and an orientation of the first ellipse and the second ellipse is determined based on known flange size information.
Embodiment 8: An apparatus including a non-transitory, computer readable, storage medium that stores instructions that, when executed by at least one processor, cause the at least one processor to perform operations including: applying a smoothing filter to an image including a flange joint; detecting at least two edges corresponding to respective flanges of the flange joint by downscaling the image and detecting edges in the downscaled image, where the detected edges are identified in a binary image; applying a transformation to extract a first ellipse and a second ellipse corresponding to the at least two detected edges identified in the binary image, where a size of the downscaled images is iteratively increased, edges detected at each iteration, and ellipses extracted based on the detected edges until ellipses are extracted from an original size image; estimating a position and an orientation of the first ellipse and the second ellipse extracted from the original size image; and quantifying an alignment of the flanges based on a position and an orientation of the first ellipse and the second ellipse.
Embodiment 9: The apparatus of any preceding embodiment, where the ellipses detected at each iteration are used to inform edge detection and ellipse extraction at a next iteration.
Embodiment 10: The apparatus of any preceding embodiment, where the smoothing filter is applied to bounding boxes of the image identified using object detection to smooth noise associated with detected objects in the image.
Embodiment 11: The apparatus of any preceding embodiment, where downscaling the image includes reducing a size of the image by a power of two and downsizing bounding boxes detected in the image.
Embodiment 12: The apparatus of any preceding embodiment, where detecting the at least two edges includes identifying edges of the respective flanges of the flange joint by calculating a gradient of an image intensity at each pixel.
Embodiment 13: The apparatus of any preceding embodiment, where quantifying an alignment of the flanges includes determining an angle of rotational misalignment or an offset of a parallel misalignment of the flanges by transforming the first ellipse and the second ellipse to real world coordinates and calculating rotational or translation misalignment based on the real world coordinates.
Embodiment 14: The apparatus of any preceding embodiment, where quantifying an alignment of the flanges based on a position and an orientation of the first ellipse and the second ellipse is determined based on known flange size information.
Embodiment 15: A system, including: one or more memory modules; one or more hardware processors communicably coupled to the one or more memory modules, the one or more hardware processors configured to execute instructions stored on the one or more memory modules to perform operations including: applying a smoothing filter to an image including a flange joint; detecting at least two edges corresponding to respective flanges of the flange joint by downscaling the image and detecting edges in the downscaled image, where the detected edges are identified in a binary image; applying a transformation to extract a first ellipse and a second ellipse corresponding to the at least two detected edges identified in the binary image, where a size of the downscaled images is iteratively increased, edges detected at each iteration, and ellipses extracted based on the detected edges until ellipses are extracted from an original size image; estimating a position and an orientation of the first ellipse and the second ellipse extracted from the original size image; and quantifying an alignment of the flanges based on a position and an orientation of the first ellipse and the second ellipse.
Embodiment 16: The system of any preceding embodiment, where the ellipses detected at each iteration are used to inform edge detection and ellipse extraction at a next iteration.
Embodiment 17: The system of any preceding embodiment, where the smoothing filter is applied to bounding boxes of the image identified using object detection to smooth noise associated with detected objects in the image.
Embodiment 18: The system of any preceding embodiment, where downscaling the image includes reducing a size of the image by a power of two and downsizing bounding boxes detected in the image.
Embodiment 19: The system of any preceding embodiment, where detecting the at least two edges includes identifying edges of the respective flanges of the flange joint by calculating a gradient of an image intensity at each pixel.
Embodiment 20: The system of any preceding embodiment, where quantifying an alignment of the flanges includes determining an angle of rotational misalignment or an offset of a parallel misalignment of the flanges by transforming the first ellipse and the second ellipse to real world coordinates and calculating rotational or translation misalignment based on the real world coordinates.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

What is claimed is:

1. A computer-implemented method that enables reconstruction of flange ellipses to detect misalignment, comprising:
applying a smoothing filter to an image comprising a flange joint;
detecting at least two edges corresponding to respective flanges of the flange joint by downscaling the image and detecting edges in the downscaled image, wherein the detected edges are identified in a binary image;
applying a transformation to extract a first ellipse and a second ellipse corresponding to the at least two detected edges identified in the binary image, wherein a size of the downscaled images is iteratively increased, edges detected at each iteration, and ellipses extracted based on the detected edges until ellipses are extracted from an original size image;
estimating a position and an orientation of the first ellipse and the second ellipse extracted from the original size image; and
quantifying an alignment of the flanges based on a position and an orientation of the first ellipse and the second ellipse.

2. The computer implemented method of claim 1, wherein the ellipses detected at each iteration are used to inform edge detection and ellipse extraction at a next iteration.

3. The computer implemented method of claim 1, wherein the smoothing filter is applied to bounding boxes of the image identified using object detection to smooth noise associated with detected objects in the image.

4. The computer implemented method of claim 1, wherein downscaling the image comprises reducing a size of the image by a power of two and downsizing bounding boxes detected in the image.

5. The computer implemented method of claim 1, wherein detecting the at least two edges comprises identifying edges of the respective flanges of the flange joint by calculating a gradient of an image intensity at each pixel.

6. The computer implemented method of claim 1, wherein quantifying an alignment of the flanges comprises determining an angle of rotational misalignment or an offset of a parallel misalignment of the flanges by transforming the first ellipse and the second ellipse to real world coordinates and calculating rotational or translation misalignment based on the real world coordinates.

7. The computer implemented method of claim 1, wherein quantifying an alignment of the flanges based on a position and an orientation of the first ellipse and the second ellipse is determined based on known flange size information.

8. An apparatus comprising a non-transitory, computer readable, storage medium that stores instructions that, when executed by at least one processor, cause the at least one processor to perform operations comprising:
applying a smoothing filter to an image comprising a flange joint;
detecting at least two edges corresponding to respective flanges of the flange joint by downscaling the image and detecting edges in the downscaled image, wherein the detected edges are identified in a binary image;
applying a transformation to extract a first ellipse and a second ellipse corresponding to the at least two detected edges identified in the binary image, wherein a size of the downscaled images is iteratively increased, edges detected at each iteration, and ellipses extracted based on the detected edges until ellipses are extracted from an original size image;
estimating a position and an orientation of the first ellipse and the second ellipse extracted from the original size image; and
quantifying an alignment of the flanges based on a position and an orientation of the first ellipse and the second ellipse.

9. The apparatus of claim 8, wherein the ellipses detected at each iteration are used to inform edge detection and ellipse extraction at a next iteration.

10. The apparatus of claim 8, wherein the smoothing filter is applied to bounding boxes of the image identified using object detection to smooth noise associated with detected objects in the image.

11. The apparatus of claim 8, wherein downscaling the image comprises reducing a size of the image by a power of two and downsizing bounding boxes detected in the image.

12. The apparatus of claim 8, wherein detecting the at least two edges comprises identifying edges of the respective flanges of the flange joint by calculating a gradient of an image intensity at each pixel.

13. The apparatus of claim 8, wherein quantifying an alignment of the flanges comprises determining an angle of rotational misalignment or an offset of a parallel misalignment of the flanges by transforming the first ellipse and the second ellipse to real world coordinates and calculating rotational or translation misalignment based on the real world coordinates.

14. The apparatus of claim 8, wherein quantifying an alignment of the flanges based on a position and an orientation of the first ellipse and the second ellipse is determined based on known flange size information.

15. A system, comprising:
one or more memory modules;
one or more hardware processors communicably coupled to the one or more memory modules, the one or more hardware processors configured to execute instructions stored on the one or more memory modules to perform operations comprising:
applying a smoothing filter to an image comprising a flange joint;
detecting at least two edges corresponding to respective flanges of the flange joint by downscaling the image and detecting edges in the downscaled image, wherein the detected edges are identified in a binary image;
applying a transformation to extract a first ellipse and a second ellipse corresponding to the at least two detected edges identified in the binary image, wherein a size of the downscaled images is iteratively increased, edges detected at each iteration, and ellipses extracted based on the detected edges until ellipses are extracted from an original size image;
estimating a position and an orientation of the first ellipse and the second ellipse extracted from the original size image; and
quantifying an alignment of the flanges based on a position and an orientation of the first ellipse and the second ellipse.

16. The system of claim 15, wherein the ellipses detected at each iteration are used to inform edge detection and ellipse extraction at a next iteration.

17. The system of claim 15, wherein the smoothing filter is applied to bounding boxes of the image identified using object detection to smooth noise associated with detected objects in the image.

18. The system of claim 15, wherein downscaling the image comprises reducing a size of the image by a power of two and downsizing bounding boxes detected in the image.

19. The system of claim 15, wherein detecting the at least two edges comprises identifying edges of the respective flanges of the flange joint by calculating a gradient of an image intensity at each pixel.

20. The system of claim 15, wherein quantifying an alignment of the flanges comprises determining an angle of rotational misalignment or an offset of a parallel misalignment of the flanges by transforming the first ellipse and the second ellipse to real world coordinates and calculating rotational or translation misalignment based on the real world coordinates.
